(19) United States
(12) Patent Application Publication
(10) Pub. No.: US 2021/0004751 A1
(43) Pub. Date: Jan. 7, 2021

(54) SYSTEM AND METHOD FOR ELECTRONICALLY MONITORING OFFICER CONTEXT CHANGE AND ACCUMULATING CORRESPONDING FORM COMPLETION TIMES AND PROVIDING AN INDICATION THEREOF

(71) Applicant: MOTOROLA SOLUTIONS, INC., CHICAGO, IL (US)

(72) Inventors: BENJAMIN ZASLOW, CHICAGO, IL (US); STEPHEN KAY, GLASGOW (GB); SALENA SOMANI, CHICAGO, IL (US)

(21) Appl. No.: 16/458,521

(22) Filed: Jul. 1, 2019

(51) Int. Cl. G06Q 10/06; G06Q 10/10

(52) U.S. Cl. CPC G06Q 10/063116; G06Q 10/1095; G06Q 10/063114

(57) ABSTRACT

Disclosed is a process for electronically monitoring officer context change and accumulating corresponding form completion times and providing a corresponding indication. A first context status change associated with an officer changing status is received. One or more corresponding particular information forms are identified via access to an electronically stored status to form mapping. A particular time required by the officer to complete the one or more particular information forms is determined via access to an electronically stored time completion indication associated with each of the one or more particular information forms. A total forms completion accumulation value is determined. The total form completion accumulation value particularly associated with the officer is provided to the officer and/or a dispatcher.

### BACKGROUND OF THE INVENTION

A police officer has to complete a lot of paperwork during each of their shifts. For example, for every incident an officer responds to, they are required to complete one or more forms, usually by the end of their current shift. In general, form completion takes an average of 21% of an officer's time (ranging from 10% up to 50%). The time between responding to incidents and attending court appearances is the only time an officer has to actively patrol and to do paperwork. An officer's schedule is highly variable shift-to-shift, and thus it is difficult for an officer to complete all their paperwork before the end of their current shift. When their paperwork is not complete by the end of their current shift, an officer must either complete their paperwork post-shift or complete their paperwork during their next shift. Completing paperwork post-shift increases officer fatigue and increases overtime costs. Further, when completing paperwork for a previous shift during their next shift, it can be difficult for an officer to recall details about incidents they responded to during the previous shift.

Thus, in order to help an officer complete forms in their highly dynamic schedule, there exists a need for an improved technical method, device, and system for monitoring the officer's context changes, accumulating corresponding form completion times, and providing indications of the form completion times.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a system for electronically monitoring officer context changes, accumulating form completion times, and providing indications of the form completion times, in accordance with some embodiments.

FIG. 2 is a device diagram showing a device structure of an electronic computing device for electronically monitoring officer context changes, accumulating form completion times, and providing indications of the form completion times, in accordance with some embodiments.

FIG. 3 illustrates a flow chart of a method for electronically monitoring officer context changes, accumulating form completion times, and providing indications of the form completion times, in accordance with some embodiments.

FIG. 4 illustrates examples of incomplete forms and an example of an officer's calendar including time blocks for form completion, in accordance with some embodiments.

FIG. 5 illustrates an example of a notification to complete forms during a time block for form completion, in accordance with some embodiments.

FIG. 6 illustrates an example of a notification indicating suggested forms to complete during a time block for form completion, in accordance with some embodiments.

FIGS. 7 and 8 illustrate an example of an officer's calendar including a form indicator line at different times during a day, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Disclosed is an improved technical method, device, and system for electronically monitoring officer context changes, accumulating corresponding form completion times, and providing indications of the form completion times. The disclosed technical solution gives an officer a realistic and informed portrayal of how much time they need to finish all their paperwork. The disclosed technical solution also gives an officer a realistic and informed portrayal of how much time they have left in their shift to complete forms. The disclosed technical solution also identifies free time that an officer has during their shift to complete forms. Further, the disclosed technical solution does not require an officer to remember all of their outstanding forms and their priority.

In one embodiment, a process for electronically monitoring officer context change and accumulating corresponding form completion times and providing an indication thereof includes: receiving, at an electronic processor of a computing device, a first context status change associated with an officer changing status from a first particular status to a second particular status, wherein the second particular status is associated with one or more particular information forms required for completion by the officer as a result of the officer obtaining the second particular status; identifying, by the electronic processor via access to an electronically stored status to form mapping, the one or more particular information forms; determining, by the electronic processor via access to an electronically stored time completion indication associated with each of the one or more particular information forms, a particular time required by the officer to complete the one or more particular information forms; adding, by the electronic processor, the particular time to a total forms completion accumulation value particularly associated with the officer; and subsequently causing, by the electronic processor, an indication of the total form completion accumulation value particularly associated with the officer to be provided to one or both of the officer and a dispatcher associated with the officer.

In a further embodiment, a computing device for electronically monitoring officer context change and accumulating corresponding form completion times and providing an indication thereof includes: a memory; a transceiver; an output interface; and an electronic processor configured to: receive a context status change associated with an officer changing status from a first particular status to a second particular status, wherein the second particular status is associated with one or more particular information forms required for completion by the officer as a result of the officer obtaining the second particular status, identify, via access to an electronically stored status to form mapping, the one or more particular information forms, determine, via access to an electronically stored time completion indication associated with each of the one or more particular information forms, a particular time required by the officer to complete the one or more particular information forms, add the particular time required to a total forms completion accumulate value particularly associated with the officer, and subsequently cause an indication of the total form completion accumulation value particularly associated with the officer to be provided to one or both of the officer and a dispatcher associated with the officer.

In a still further embodiment, a non-transient computer readable medium containing program instructions for causing a computer to perform a set of functions including: receive a context status change associated with an officer changing status from a first particular status to a second particular status, wherein the second particular status is associated with one or more particular information forms required for completion by the officer as a result of the officer obtained the second particular status; identify, via access to an electronically stored status to form mapping, the one or more particular information forms; determine, via access to an electronically stored time completion indication associated with each of the one or more particular information forms, a particular time required by the officer to complete the one or more particular information forms; add the particular time required to a total forms completion accumulate value particularly associated with the officer; and subsequently cause an indication of the total form completion accumulation value particularly associated with the officer to be provided to one or both of the officer and a dispatcher associated with the officer.

Each of the above-mentioned embodiments will be discussed in more detail below, starting with example communication system and device architectures of the system in which the embodiments may be practiced, followed by an illustration of processing blocks for achieving an improved technical method, device, and system for monitoring officer context changes, accumulating corresponding form completion times, and providing indications of the form completion times. Further advantages and features consistent with this disclosure will be set forth in the following detailed description, with reference to the figures.

1. Communication System and Device Structures

a. Communication System Structure

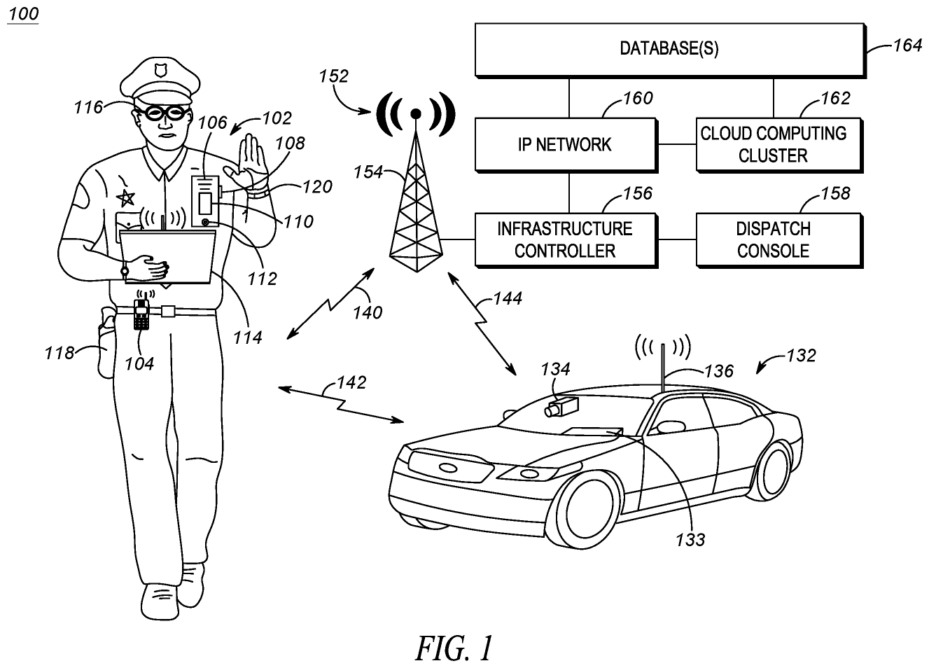

Referring now to the drawings, and in particular FIG. 1, a communication system diagram illustrates a system 100 of devices including a first set of devices that a user 102 (illustrated in FIG. 1 as a first responder police officer) may wear, such as a primary battery-powered portable radio 104 used for narrowband and/or broadband direct-mode or infrastructure communications, a battery-powered radio speaker microphone (RSM) video capture device 106, a laptop 114 having an integrated video camera and used for data applications such as incident support applications, smart glasses 116 (e.g., which may be virtual reality, augmented reality, or mixed reality glasses, may include a video camera, and/or may include a head-tracking and/or eye-tracking function), sensor-enabled holster 118, and/or biometric sensor wristband 120.

System 100 may also include a vehicle 132 associated with the user 102 having an integrated vehicular computing device 133, an associated vehicular video camera 134, and a coupled vehicular transceiver 136. Although FIG. 1 illustrates only a single instance of vehicle 132 with a respective single instance of vehicular computing device 133, single vehicular video camera 134 and single vehicular transceiver 136, in other embodiments, the vehicle 132 may include additional same or similar computing devices, video cameras and/or transceivers, and additional vehicles may be present with respective additional sets of computing devices, video cameras, and/or transceivers.

Each of the portable radio 104, the RSM video capture device 106, the laptop 114, and the vehicular computing device 133 may be capable of directly wirelessly communicating via direct-mode wireless link(s) 142, and/or may be capable of wirelessly communicating via a wireless infrastructure radio access network (RAN) 152 over respective wireless link(s) 140, 144 and via corresponding transceiver circuits.

Many of the devices shown in FIG. 1 (such as the portable radio 104, the RSM video capture device 106, the laptop 114, the vehicular computing device 133, the infrastructure controller 156, dispatch console 158, and one or more computing devices in the cloud computing cluster 162) may be referred to as communication devices. Although FIG. 1 shows multiple communication devices associated with the user 102, in some embodiments, the communication system 100 includes communication devices of multiple users.

In some embodiments, the communication devices communicate with each other over the infrastructure RAN 152 and/or communicate with each other directly as described herein. Similarly, other devices, such as the dispatch console 158, may communicate with communication devices of multiple users through the infrastructure RAN 152. In some embodiments, one or more users may have multiple associated communication devices, for example, as shown in FIG. 1.

The portable radio 104, in particular, may be any mobile computing device used for infrastructure RAN or direct-mode media (e.g., voice, audio, video, etc.) communication via a long-range wireless transmitter and/or transceiver that has a transmitter transmit range on the order of miles, e.g., 0.5-50 miles, or 3-20 miles (e.g., in comparison to a short-range transmitter such as a Bluetooth, Zigbee, or NFC transmitter) with other mobile computing devices and/or the infrastructure RAN 152. The long-range transmitter may implement a direct-mode, conventional, or trunked land mobile radio (LMR) standard or protocol such as ETSI Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, the long range transmitter may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

In the example of FIG. 1, the portable radio 104 may form the hub of communication connectivity for the user 102, through which other accessory devices such as a biometric sensor (for example, the biometric sensor wristband 120), an activity tracker, a weapon status sensor (for example, the sensor-enabled holster 118), a heads-up-display (for example, the smart glasses 116), the RSM video capture device 106, and/or the laptop 114 may communicatively couple.

In order to communicate with and exchange video, audio, and other media and communications with the RSM video capture device 106, laptop 114, and/or smart glasses 116, the portable radio 104 may contain one or more physical electronic ports (such as a USB port, an Ethernet port, an audio jack, etc.) for direct electronic coupling with the RSM video capture device 106, laptop 114, and/or smart glasses 116 and/or may contain a short-range transmitter (e.g., in comparison to the long-range transmitter such as a LMR or Broadband transmitter) and/or transceiver for wirelessly coupling with the RSM video capture device 106, laptop 114, and/or smart glasses 116. The short-range transmitter may be a Bluetooth, Zigbee, or NFC transmitter having a transmit range on the order of 0.01-100 meters, or 0.1 to 10 meters.

In other embodiments, the RSM video capture device 106, the laptop 114, and/or the smart glasses 116 may contain their own long-range transceivers and may communicate with one another and/or with the infrastructure RAN 152 or vehicular transceiver 136 directly without passing through portable radio 104.

The RSM video capture device 106, in particular, provides voice functionality features similar to a traditional RSM, including one or more of acting as a remote microphone that is closer to the user's 102 mouth, providing a remote speaker allowing play back of audio closer to the user's 102 ear, and including a PTT switch or other type of PTT input. The voice and/or audio recorded at the remote microphone may be provided to the portable radio 104 for storage and/or analysis or for further transmission to other mobile communication devices or the infrastructure RAN 152, or may be directly transmitted by the RSM video capture device 106 to other mobile computing devices or to the infrastructure RAN 152. The voice and/or audio played back at the remote speaker may be received from the portable radio 104 or received directly from one or more other mobile computing devices or the infrastructure RAN 152. The RSM video capture device 106 may include a separate physical PTT switch 108 that functions, in cooperation with the portable radio 104 or on its own, to maintain the portable radio 104 and/or RSM video capture device 106 in a monitor only mode, and which switches the device(s) to a transmit-only mode (for half-duplex devices) or transmit and receive mode (for full-duplex devices) upon depression or activation of the PTT switch 108. The portable radio 104 and/or RSM video capture device 106 may form part of a group communications architecture that allows a single mobile computing device to communicate with one or more group members (not shown) associated with a particular group of devices at a same time.

Additional features may be provided at the RSM video capture device 106 as well. For example, a display screen 110 may be provided for displaying images, video, and/or text to the user 102 or to someone else. The display screen 110 may be, for example, a liquid crystal display (LCD) screen or an organic light emitting display (OLED) display screen. In some embodiments, a touch sensitive input interface may be incorporated into the display screen 110 as well, allowing the user 102 to interact with content provided on the display screen 110. A soft PTT input may also be provided, for example, via such a touch interface.

A video camera 112 may be further provided at the RSM video capture device 106, integrating an ability to capture images and/or video and store the captured image data (for further analysis) or transmit the captured image data as an image or video stream to the portable radio 104 and/or to other mobile computing devices or to the infrastructure RAN 152 directly. The video camera 112 and RSM remote microphone may be used, for example, for capturing audio and/or video of a field-of-view associated with the user 102, storing the captured audio and/or video data for further analysis or transmitting the captured audio and/or video data as an audio and/or video stream to the portable radio 104 and/or to other mobile computing devices or to the infrastructure RAN 152 directly for further analysis. The RSM remote microphone may be an omni-directional or unidirectional microphone or array of omni-directional or unidirectional microphones that may be capable of identifying a direction from which a captured sound emanated.

In some embodiments, the RSM video capture device 106 may be replaced with a more limited body worn camera that may include the video camera 112 and/or microphone noted above for capturing audio and/or video, but may forego one or more of the features noted above that transform the body worn camera into a more full featured RSM, such as the separate physical PTT switch 108 and the display screen 110, and remote microphone functionality for voice communications in cooperation with portable radio 104.

The laptop 114, in particular, may be any wireless computing device used for infrastructure RAN or direct-mode media communication via a long-range and/or short-range wireless transmitter with other mobile computing devices and/or the infrastructure RAN 152. The laptop 114 includes a display screen for displaying a user interface to an operating system and one or more applications running on the operating system, such as a broadband PTT communications application, a web browser application, a vehicle history database application, a workflow application, a forms or reporting tool application, an arrest record database application, an outstanding warrant database application, a mapping and/or navigation application, a health information database application, or other types of applications that may require user interaction to operate. The laptop 114 display screen may be, for example, an LCD screen or an OLED display screen. In some embodiments, a touch sensitive input interface may be incorporated into the display screen as well, allowing the user 102 to interact with content provided on the display screen. A soft PTT input may also be provided, for example, via such a touch interface.

Front and/or rear-facing video cameras may be further provided at the laptop 114, integrating an ability to capture video and/or audio of the user 102 and/or a field of view substantially matching the user's 102, and store and/or otherwise process the captured video and/or audio for further analysis or transmit the captured video and/or audio as a video and/or audio stream to the portable radio 104, other mobile computing devices, and/or the infrastructure RAN 152 for further analysis.

The smart glasses 116 may include a digital imaging device, a computing device, a short-range and/or long-range transceiver device, and/or a projecting device. The smart glasses 116 may maintain a bi-directional communications connection with the portable radio 104 and provide an always-on or on-demand video feed pointed in a direction of the user's 102 gaze via the digital imaging device, and/or may provide a personal display via the projection device integrated into the smart glasses 116 for displaying to its user information such as text, images, or video received from the portable radio 104 or directly from the infrastructure RAN 152. In some embodiments, an additional user interface mechanism such as a touch interface or gesture detection mechanism may be provided at the smart glasses 116 that allows the user 102 to interact with the display elements displayed on the smart glasses 116 or projected into the user's 102 eyes, or to modify operation of the digital imaging device, while in other embodiments, a display and input interface at the portable radio 104 may be provided for interacting with smart glasses 116 content and modifying operation of the digital imaging device, among other possibilities.

The smart glasses 116 may provide a virtual reality interface in which a computer-simulated reality electronically replicates an environment with which the user 102 may interact, may provide an augmented reality interface in which a direct or indirect view of real-world environments in which the user is currently disposed are augmented, i.e., supplemented, by additional computer-generated sensory input such as sound, video, images, graphics, GPS data, or other information, or may provide a mixed reality interface in which electronically generated objects are inserted in a direct or indirect view of real-world environments in a manner such that they may co-exist and interact in real time with the real-world environment and real world objects.

The sensor-enabled holster 118 may be an active (powered) or passive (non-powered) sensor that maintains and/or provides state information regarding a weapon or other item normally disposed within the user's 102 sensor-enabled holster 118. The sensor-enabled holster 118 may detect a change in state (presence to absence) and/or an action (removal) relative to the weapon normally disposed within the sensor-enabled holster 118. The detected change in state and/or action may be reported to the portable radio 104 via its short-range transceiver. In some embodiments, the sensor-enabled holster 118 may also detect whether the first responder's hand is resting on the weapon even if it has not yet been removed from the holster and provide such information to portable radio 104. Other possibilities exist as well.

The biometric sensor wristband 120 may be an electronic device for tracking an activity of the user 102 or a health status of the user 102, and may include one or more movement sensors (such as an accelerometer, magnetometer, and/or gyroscope) that may periodically or intermittently provide to the portable radio 104 indications of orientation, direction, steps, acceleration, and/or speed, and indications of health such as one or more of a captured heart rate, a captured breathing rate, and a captured body temperature of the user 102, perhaps accompanying other information. In some embodiments, the biometric sensor wristband 120 may include its own long-range transceiver and may communicate with other communication devices and/or with the infrastructure RAN 152 or vehicular transceiver 136 directly without passing through portable radio 104.

An accelerometer is a device that measures acceleration. Single and multi-axis models are available to detect magnitude and direction of the acceleration as a vector quantity, and can be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and can be used to determine a direction in which a person or device is facing.

Although the biometric sensor wristband 120 is shown in FIG. 1 as a bracelet worn around the wrist, in other examples, the biometric sensor wristband 120 may additionally and/or alternatively be worn around another part of the body, or may take a different physical form including an earring, a finger ring, a necklace, a glove, a belt, or some other type of wearable, ingestible, or insertable form factor.

The portable radio 104, RSM video capture device 106, laptop 114, smart glasses 116, sensor-enabled holster 118, and/or biometric sensor wristband 120 may form a personal area network (PAN) via corresponding short-range PAN transceivers, which may be based on a Bluetooth, ZigBee, or other short-range wireless protocol having a transmission range on the order of meters, tens of meters, or hundreds of meters.

The portable radio 104 and/or RSM video capture device 106 (or any other device in FIG. 1 for that matter) may each include a location determination device integrated with or separately disposed but communicably coupled to the portable radio 104 and/or RSM video capture device 106 and/or in respective receivers, transmitters, or transceivers of the portable radio 104 and RSM video capture device 106 for determining a location of the portable radio 104 and RSM video capture device 106. The location determination device may be, for example, a global positioning system (GPS) receiver or wireless triangulation logic using a wireless receiver or transceiver and a plurality of wireless signals received at the wireless receiver or transceiver from different locations, among other possibilities. The location determination device may also include an orientation sensor for determining an orientation that the device is facing. Each orientation sensor may include a gyroscope and/or a magnetometer. Other types of orientation sensors could be used as well. The location (and/or orientation) can then be stored locally and/or transmitted via the transmitter or transceiver to other computing devices and/or to the infrastructure RAN 152.

The vehicle 132 may include the vehicular computing device 133, the vehicular video camera 134, and the vehicular transceiver 136, all of which may be coupled to one another via a wired and/or wireless vehicle area network (VAN), perhaps along with other sensors physically or communicatively coupled to the vehicle 132. The vehicular transceiver 136 may include a long-range transceiver for directly wirelessly communicating with mobile computing devices such as the portable radio 104, the RSM video capture device 106, and the laptop 114 via wireless link(s) 142 and/or for wirelessly communicating with the infrastructure RAN 152 via wireless link(s) 144. The vehicular transceiver 136 may further include a short-range wireless transceiver or wired transceiver for communicably coupling between the vehicular computing device 133 and/or the vehicular video camera 134 in the VAN. The vehicular computing device 133 may, in some embodiments, include the vehicular transceiver 136 and/or the vehicular video camera 134 integrated therewith, and may operate to store and/or process video and/or audio produced by the vehicular video camera 134 and/or transmit the captured video and/or audio as a video and/or audio stream to the portable radio 104, other mobile computing devices, and/or the infrastructure RAN 152 for further analysis. An omni-directional or unidirectional microphone (not shown), or an array thereof, may be integrated in the vehicular video camera 134 and/or at the vehicular computing device 133 (or additionally or alternatively made available at a separate location of the vehicle 132) and communicably coupled to the vehicular computing device 133 and/or vehicular transceiver 136 for capturing audio and storing, processing, and/or transmitting the audio in a same or similar manner as set forth above with respect to the RSM video capture device 106.

The vehicle 132 may be a human-operable vehicle, or may be a self-driving vehicle operable under control of vehicular computing device 133 perhaps in cooperation with vehicular video camera 134 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link).

The vehicle 132 and/or vehicular transceiver 136, similar to the portable radio 104 and/or respective receivers, transmitters, or transceivers thereof, may include a location (and/or orientation) determination device integrated with or separately disposed in the vehicular computing device 133 and/or vehicular transceiver 136 for determining (and storing and/or transmitting) a location (and/or orientation) of the vehicle 132.

In some embodiments, instead of a vehicle 132, a land, air, or water-based drone with same or similar audio and/or video and communications capabilities and same or similar self-navigating capabilities as set forth above may be disposed, and may similarly communicate with the user's 102 PAN and/or with the infrastructure RAN 152 to support the user 102 in the field.

The VAN may communicatively couple with the PAN disclosed above when the VAN and the PAN come within wireless transmission range of one another, perhaps after an authentication takes place there between, and one of the VAN and the PAN may provide infrastructure communications to the other, depending on the situation and the types of devices in the VAN and/or PAN and may provide interoperability and communication links between devices (such as video cameras) and sensors within the VAN and PAN.

Although the RSM video capture device 106, the laptop 114, the smart glasses 116, and the vehicle 132 are illustrated in FIG. 1 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, other types of body worn cameras such as head-mounted cameras, other types of vehicular cameras such as roof-mounted cameras, or other types of audio and/or video recording devices accessible via a wired or wireless network interface same or similar to that disclosed herein.

Infrastructure RAN 152 is a radio access network that provides for radio communication links to be arranged within the network between a plurality of user terminals. Such user terminals may be mobile and may be known as ‘mobile stations’ or ‘mobile devices,’ and may include any one or more of the electronic computing devices illustrated in FIG. 1, among other possibilities. At least one other terminal, e.g. used in conjunction with mobile devices, may be a fixed terminal, e.g. a base station, eNodeB, repeater, and/or access point. Such a RAN typically includes a system infrastructure that generally includes a network of various fixed terminals, which are in direct radio communication with the mobile devices. Each of the fixed terminals operating in the RAN may have one or more transceivers which may, for example, serve mobile devices in a given region or area, known as a ‘cell’ or ‘site’, by radio frequency (RF) communication. The mobile devices that are in direct communication with a particular fixed terminal are said to be served by the fixed terminal. In one example, all radio communications to and from each mobile device within the RAN are made via respective serving fixed terminals. Sites of neighboring fixed terminals may be offset from one another and may provide corresponding non-overlapping or partially or fully overlapping RF coverage areas.

Infrastructure RAN 152 may operate according to an industry standard wireless access technology such as, for example, an LTE, LTE-Advance, or 5G technology over which an OMA-PoC, a VoIP, an LTE Direct or LTE Device to Device, or a PoIP application may be implemented. Additionally or alternatively, infrastructure RAN 152 may implement a WLAN technology such as Wi-Fi perhaps operating in accordance with an IEEE 802.11 standard (e.g., 802.11a, 802.11b, 802.11g) or such as a WiMAX perhaps operating in accordance with an IEEE 802.16 standard.

Infrastructure RAN 152 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated as narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-PoC, in particular and as one example of an infrastructure broadband wireless application, enables familiar PTT and “instant on” features of traditional half-duplex mobile devices, but uses mobile devices operating over modern broadband telecommunications networks. Using OMA-PoC, wireless mobile devices such as mobile telephones and notebook computers can function as PTT half-duplex mobile devices for transmitting and receiving. Other types of PTT models and multimedia call models (MMCMs) could be used as well.

Floor control in an OMA-PoC session is generally maintained by a PTT server that controls communications between two or more wireless mobile devices. When a user of one of the mobile devices keys a PTT button, a request for permission to speak in the OMA-PoC session is transmitted from the user's mobile device to the PTT server using, for example, a real-time transport protocol (RTP) message. If no other users are currently speaking in the PoC session, an acceptance message is transmitted back to the user's mobile device and the user can then speak into a microphone of the device. Using standard compression/decompression (codec) techniques, the user's voice is digitized and transmitted using discrete auditory data packets (e.g., together which form an auditory data stream over time), such as according to RTP and internet protocols (IP), to the PTT server. The PTT server then transmits the auditory data packets to other users of the PoC session (e.g., to other mobile devices in the group of mobile devices or talkgroup to which the user is subscribed), using for example, one or more of a unicast, point to multipoint, or broadcast communication technique.

Infrastructure narrowband LMR wireless systems, on the other hand, may operate in either a conventional or trunked configuration. In either configuration, a plurality of mobile devices is partitioned into separate groups of mobile devices.

In a conventional narrowband radio system, each mobile device in a group is selected to a particular radio channel (frequency or frequency & time slot) for communications associated with that mobile device's group. Thus, each group is served by one channel, and multiple groups may share the same single frequency (in which case, in some embodiments, group IDs may be present in the group data to distinguish between groups using the same shared frequency).

In contrast, a trunked narrowband radio system and its mobile devices use a pool of traffic channels for virtually an unlimited number of groups of mobile devices (e.g., talkgroups). Thus, all groups are served by all channels. The trunked radio system works to take advantage of the probability that not all groups need a traffic channel for communication at the same time. When a member of a group requests a call on a control or rest channel on which all of the mobile devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the mobile devices were idling to a traffic channel for the call, and instruct all mobile devices that are not participating in the new call to move to a newly assigned control or rest channel selected from the pool of available channels. With a given number of channels, a much greater number of groups can be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., mobile devices) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, mobile devices may dynamically affiliate with a group (and also disassociate with the group) perhaps based on user input, and the switching and/or radio network may track group membership and route new group calls according to the current group membership.

In some instances, broadband and narrowband systems may be interfaced via a middle-ware system that translates between a narrowband PTT standard protocol (such as P25) and a broadband PTT standard protocol (such as OMA-PoC). Such intermediate middle-ware may include a middleware server for performing the translations and may be disposed in the cloud, disposed in a dedicated on-premises location for a client wishing to use both technologies, or disposed at a public carrier supporting one or both technologies. For example, and with respect to FIG. 1, such a middle-ware server may be disposed in infrastructure RAN 152 at infrastructure controller 156 or at a separate cloud computing cluster 162 communicably coupled to infrastructure controller 156 via internet protocol (IP) network 160, among other possibilities.

The infrastructure RAN 152 is illustrated in FIG. 1 as providing coverage for the portable radio 104, RSM video capture device 106, laptop 114, smart glasses 116, and/or vehicle transceiver 136 via a single fixed terminal 154 coupled to a single instance of infrastructure controller 156 (e.g., radio controller, call controller, PTT server, zone controller, MME, BSC, MSC, site controller, Push-to-Talk controller, or other network device) and including a dispatch console 158 operated by a dispatcher. In other embodiments, additional fixed terminals and additional controllers may be disposed to support a larger geographic footprint and/or a larger number of mobile devices.

The infrastructure controller 156 illustrated in FIG. 1, or some other backend electronic computing device existing on-premises or in the remote cloud computing cluster 162 accessible via the IP network 160 (such as the Internet), may additionally or alternatively operate as a back-end electronic digital assistant, a back-end audio and/or video processing electronic computing device, and/or a remote cloud-based storage device consistent with the remainder of this disclosure.

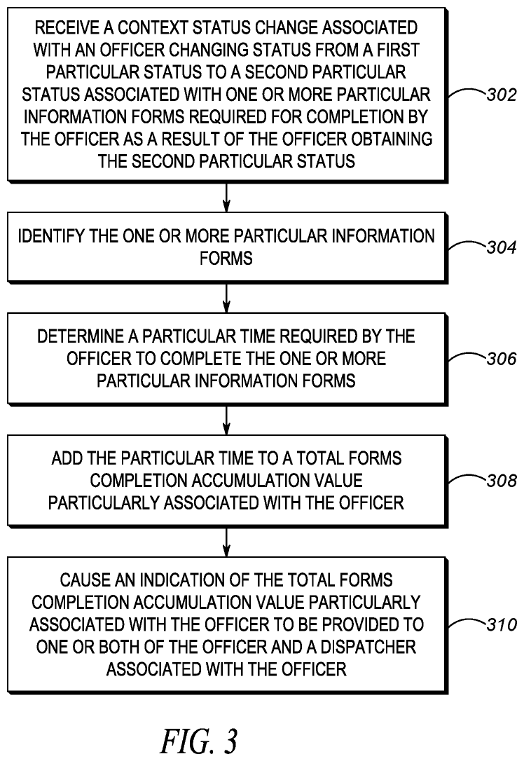

The IP network 160 may comprise one or more routers, switches, LANs, WLANs, WANs, access points, or other network infrastructure, including but not limited to, the public Internet. The cloud computing cluster 162 may be comprised of a plurality of computing devices, such as the one set forth in FIG. 3, one or more of which may be executing none, all, or a portion of an electronic digital assistant service, sequentially or in parallel, across the plurality of computing devices. The plurality of computing devices comprising the cloud computing cluster 162 may be geographically co-located or may be separated by inches, meters, or miles, and inter-connected via electronic and/or optical interconnects. Although not shown in FIG. 1, one or more proxy servers or load-balancing servers may control which one or more computing devices perform any part or all of the electronic digital assistant function.

As shown in FIG. 1, database(s) 164 may be accessible via the IP network 160 and/or the cloud computing cluster 162. As shown in FIG. 1, the database(s) 164 are communicatively coupled with the infrastructure RAN 152 to allow the communication devices (for example, the portable radio 104, the RSM video capture device 106, the laptop 114, and the vehicular computing device 133) to communicate with and retrieve data from the database(s) 164 via infrastructure controller 156 and IP network 160. In some embodiments, the database(s) 164 are commercial cloud-based storage devices. In some embodiments, the database(s) 164 are housed on suitable on-premises database servers. The database(s) may include databases such as a long-term video storage database, a historical or forecasted weather database, an offender database perhaps including facial recognition images to match against, a cartographic database of streets and elevations, a traffic database of historical or current traffic conditions, incident database including data such as incident assignment and timeline of incidents, or other types of databases. Database(s) 164 may further include all or a portion of the databases described herein as being provided at the infrastructure controller 156. In some embodiments, the database(s) 164 may be maintained by third parties (for example, the National Weather Service or a Department of Transportation, respectively). The database(s) 164 of FIG. 1 are merely examples. In some embodiments, the system 100 additionally or alternatively includes other databases that store different information. In some embodiments, the database(s) 164 and/or additional or other databases are integrated with, or internal to, the infrastructure controller 156.

Finally, although FIG. 1 describes a communication system 100 generally as a public safety communication system including a user 102 generally described as a police officer and vehicle 132 generally described as a police cruiser, in other embodiments, the communications system 100 may additionally or alternatively be a private security communications system including a user 102 that may be an employee of a private security company and a vehicle 132 that may be a vehicle for use by the user 102 in furtherance of the private security employee's duties (e.g., a private security vehicle or motorcycle). Still other possibilities exist as well.

b. Device Structure

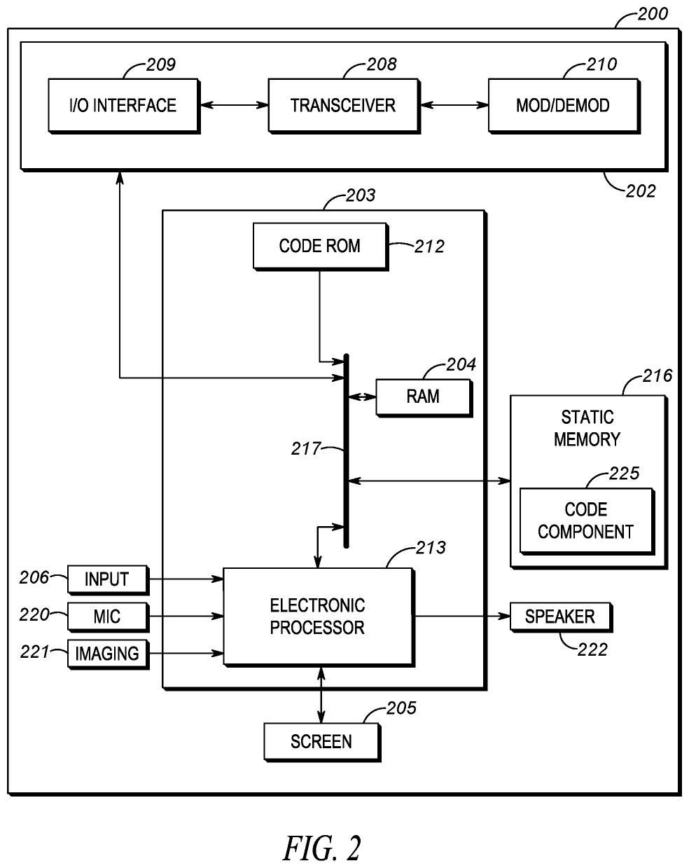

FIG. 2 sets forth a schematic diagram that illustrates a communication device 200 according to some embodiments of the present disclosure. The communication device 200 may be, for example, embodied in the portable radio 104, the RSM video capture device 106, the laptop 114, the vehicular computing device 133, the infrastructure controller 156, the dispatch console 158, one or more computing devices in the cloud computing cluster 162, or some other communication device not illustrated in FIG. 1, and/or may be a distributed communication device across two or more of the foregoing (or multiple of a same type of one of the foregoing) and linked via a wired and/or wireless communication link(s). In some embodiments, the communication device 200 (for example, the portable radio 104) may be communicatively coupled to other devices such as the sensor-enabled holster 118 as described above. In such embodiments, the combination of the portable radio 104 and the sensor-enabled holster 118 may be considered a single communication device 200.

While the communication device 200 in FIG. 2 may represent one or more of the devices as described above with respect to FIG. 1, depending on the type of the communication device, the communication device 200 or other devices may include fewer or additional components in configurations different from that illustrated in FIG. 2. For example, in some embodiments, the communication device 200 acting as the infrastructure controller 156 of FIG. 1 may not include one or more of the screen 205, microphone 220, imaging device 221, and speaker 222. As another example, in some embodiments, the communication device 200 acting as the portable radio 104 of the RSM video capture device 106 of FIG. 1 may further include a location determination device (for example, a global positioning system (GPS) receiver) as explained above. Other combinations are possible as well.

As shown in FIG. 2, the communication device 200 includes a communications unit 202 coupled to a common data and address bus 217 of a processing unit 203. The communication device 200 may also include one or more input devices (for example, keypad, pointing device, touch-sensitive surface, button, a microphone 220, an imaging device 221, and/or another input device 206) and a screen 205 (which, in some embodiments, may be an electronic display touch screen and thus also acts as an input device), each coupled to be in communication with the processing unit 203.

The microphone 220 may be present for capturing audio from a user and/or other environmental or background audio that is further processed by processing unit 203 in accordance with the remainder of this disclosure and/or is transmitted as voice or audio stream data, or as acoustical environment indications, by communications unit 202 to other portable radios and/or other communication devices. The imaging device 221 may provide video (still or moving images) of an area in a field of view of the communication device 200 for further processing by the processing unit 203 and/or for further transmission by the communications unit 202. A speaker 222 may be present for reproducing audio that is decoded from voice or audio streams of calls received via the communications unit 202 from other portable radios, from digital audio stored at the communication device 200, from other ad-hoc or direct mode devices, and/or from an infrastructure RAN device, or may playback alert tones or other types of pre-recorded audio.

The processing unit 203 may include a code Read Only Memory (ROM) 212 coupled to the common data and address bus 217 for storing data for initializing system components. The processing unit 203 may further include an electronic processor 213 (for example, a microprocessor or another electronic device) coupled, by the common data and address bus 217, to a Random Access Memory (RAM) 204 and a static memory 216.

The communications unit 202 may include one or more wired and/or wireless input/output (I/O) interfaces 209 that are configurable to communicate with other communication devices, such as the portable radio 104, the laptop 114, the wireless infrastructure RAN 152, and/or the vehicular computing device 133, over which incoming calls may be received and over which communications with remote databases and/or servers may occur.

For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (for example, 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The electronic processor 213 has ports for coupling to the screen 205, the microphone 220, the imaging device 221, the other input device 206, and/or the speaker 222. Static memory 216 may store operating code 225 for the electronic processor 213 that, when executed, performs one or more of the blocks set forth in FIG. 3 and the accompanying text. The static memory 216 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, and the like.

2. Processes for Electronically Monitoring Officer Context Change, Accumulating Corresponding Form Completion Times, and Providing Indications of the Form Completion Times

FIG. 3 illustrates a flow chart diagram of a process 300 performed by an electronic computing device for electronically monitoring officer context change, accumulating corresponding form completion times, and providing an indication of the form completion times. The electronic computing device performing one or more of the blocks set forth in FIG. 3 may include, as just examples, the portable radio 104, the RSM video capture device 106, the laptop 114, or the vehicular computing device 133 of FIG. 1. Alternatively or in addition, the electronic computing device performing one or more of the blocks set forth in FIG. 3 may include the electronic computing device 200 of FIG. 2. The electronic computing device performing one or more of the blocks set forth in FIG. 3 may include Other example portable computing devices are possible as well, including mobile computing devices such as so-called smart phones operating on an Apple iOS™ or Google Android™ operating system. While a particular order of processing steps or blocks, message receptions, and/or message transmissions is indicated in FIG. 3 as an example, timing and ordering of such blocks, receptions, and transmissions may vary where appropriate without negating the purpose and advantages of the examples set forth in detail throughout the remainder of this disclosure.

Process 300 begins at block 302, where the electronic computing device receives a context status change (an example of a “first context status change”) associated with an officer changing status from a first particular status to a second particular status that is associated with one or more particular information forms required for completion by the officer as a result of the officer obtaining the second particular status. In some embodiments, the second particular status includes the officer being assigned to respond to a particular incident of a particular incident type. As previously described herein, officers typically need to complete one or more information forms when they respond to an incident. As a first example, the officer may receive a radio call while on patrol to respond to a domestic disturbance, which will require the officer to complete one or more information forms. As a second example, the officer may witness and respond to a robbery in progress while on patrol, which again will require the officer to complete one or more information forms. Alternatively or in addition, the second particular status includes the officer engaging in an encounter with one or more civilians. For example, the second particular status may include the officer conducting a field interview with a civilian that requires completion of a field interview card. A field interview card (also known as a contact card, an information card, and an interview card) may be used to document a contact with a civilian which does not rise to the level of an arrest or citation being issued (e.g., a traffic citation or a local ordinance violation). For example, if an officer assigned at a university conducts a welfare check on an intoxicated student, the officer may document the contact on a field interview card instead of writing an underage drinking ticket. As a further example, an officer on patrol in a neighbor may complete a field interview card to document a brief informal conversation with a civilian about general activity in the neighborhood.

In some embodiments, the first particular status may include the officer being in an idle or available state. For example, in the first particular state, the officer may be out patrolling a neighborhood or parked on the side of a road to catch speeding motor vehicles. Alternatively or in addition, the first particular status may include the officer responding to an incident. For example, in the first particular state, the officer may be responding to a robbery or issuing a traffic citation to a motorist for a moving violation.

In some embodiments, the context status change includes (or is included as part of) a command from a dispatcher (e.g., associated with the dispatch console 158) assigning the officer to respond to an incident, a request from a dispatcher for the officer to respond to an incident, an acknowledgement from the officer to a dispatcher that the officer is responding to an incident as requested, a status update from the officer to a dispatcher indicating that the officer is responding to an incident, or a combination thereof. In some embodiments, the electronic computing device receives the context status change from one or more communication devices (such as the portable radio 104, the RSM video capture device 106, the laptop 114, the vehicular computing device 133, the infrastructure controller 156, dispatch console 158, and one or more computing devices in the cloud computing cluster 162). As a first example, the context status change may be included in communication between the officer and a dispatcher, or between the officer and another officer. As a second example, the context status change may be included as part of user input provided by the officer (e.g., via the portable radio 104 or the laptop 114 illustrated in FIG. 1).

At block 304, the electronic computing device identifies the one or more particular information forms required for completion by the officer as a result of the officer obtaining the second particular status. The electronic computing device identifies the one or more particular information forms via access to an electronically stored status to form mapping. For example, a status to form mapping may be stored at the electronic computing device (or at the infrastructure controller 156, the cloud computing cluster 162, or the database(s) 164 of FIG. 1) that indicates the information forms required for completion for each possible type of second particular status the officer can have. In some embodiments, the electronic computing device may identify the one or more particular information forms based on the particular type of incident which the officer is responding to as part of obtaining the second particular status. For example, the officer may need to complete at least three particular information forms when responding to a car accident and at least five particular forms when responding to a robbery. Alternatively or in addition, the electronic computing device may identify the one or more particular information forms based on specific details of the incident which the officer is responding to as part of obtaining the second particular status. For example, the officer may need to complete three particular information forms when responding to a car accident with no injuries and/or no arrests and four particular information forms when responding to a car accident with injuries and/or arrests. Alternatively or in addition, the electronic computing device may identify a field information card as the particular information form when the officer has an impromptu encounter or informal conversation with a civilian as part of obtaining the second particular status.

At block 306, the electronic computing device determines a particular time required by the officer to complete the one or more particular information forms. Each information form may include one or more form sections. Each form section may include one or more form fields. For example, an information form may include a first form section for a first witness and a second form section for a second witness. The two form sections may each include a plurality of similar form fields. For example, each form section may include, among other things, form fields for witness name, witness address, and witness contact phone number. In some embodiments, the particular time required to complete a particular information form includes the total amount of time required to complete every form field included in the particular information form. For example, with an information form including six different form fields, the total amount of time required to complete the information form may be the sum of the amounts of time required to complete each of the six form fields. Alternatively or in addition, the particular time required to complete a particular information form includes the total amount of time required to complete only the required forms fields of the information form because the information form may include additional form fields (i.e., optional form fields) that do not need to be completed for the specific type of incident that the officer is responding to. For example, an information form for a car accident may include form fields that only need to be completed when someone is injured.

In some embodiments, the electronic computing device determines the particular time required by the officer to complete the one or more particular information forms by accessing an electronically stored time completion indication associated with each of the one or more particular information forms. In some embodiments, the electronic computing device determines the particular time required by the officer to complete a particular information form by extracting the particular time from metadata embedded within retrieved copies of the one or more particular information forms. Alternatively or in addition, the electronic computing device determines the particular time required by the officer to complete a particular information form by retrieving the particular time from the electronically stored status to form mapping described previously herein. Alternatively or in addition, the electronic computing device determines the particular time required by the officer to complete a particular information form by retrieving the particular time from a form completion database separate from the electronically stored status to form mapping. For example, the form completion database may be included in the database(s) 164 of FIG. 1.

In some embodiments, the electronic computing devices determines the particular time required by the officer to complete a particular information form based on a stored calculated historical average for the officer to complete the particular information form. For example, in the past, the officer may take, on average, 30 minutes to complete the particular information form. Alternatively or in addition, the electronic computing devices determines the particular time required by the officer to complete a particular information form based on a (unweighted or weighted based on how recent, type of officer, rank of officer, experience of officer, etc.) stored calculated historical average for all or a plurality of other officers to complete the particular information form. For example, in the past, the average time for all or a plurality of other officers to complete the particular information form may be 40 minutes.

For some incidents, the different information forms that need to be completed have similar form fields. For example, two information forms for responding to a robbery may both have a form field for information about a first witness. In some embodiments, matching form fields of separate forms are electronically linked such that information entered into one of the forms is auto-populated to the other forms. Thus, the total time to complete multiple forms may be reduced because the officer only needs to enter the information once. In some embodiments, the electronic computing device determines the particular time required by the officer to complete every particular information form for an incident by eliminating overlapping form fields of the particular information forms. The elimination of overlapping forms field may be used in embodiments where the electronic computing device subsequently auto-populates overlapping form fields when a first instance of the overlapping form field is populated by the officer.

At block 308, the electronic computing device adds the particular time required to complete the one or more information forms to a total forms completion accumulation value particularly associated with the officer. The total forms completion accumulation value represents an estimate of the total amount of time that the officer will need to spend filling out information forms to finish every incomplete information form that the officer needs to complete. In some embodiments, prior to block 408, the total forms completion accumulation value includes the total amount of time required to finish every incomplete information form from every incident that the officer responded to during the current shift prior to obtaining the second particular status. For example, the total forms completion accumulation value may include the total amount of time required to finish incomplete information forms for three separate incidents that the officer responded to during the current shift prior to obtaining the second particular status. In some embodiments, in addition to including the time required to finish incomplete information forms for incidents the officer previously responded to during the current shift, the total forms completion accumulation value further includes the time required to finish incomplete information forms for incidents that the officer responded to during a previous shift. For example, the officer may not have had sufficient time to complete every information form for every incident that the officer responded to during a previous shift, and thus the officer needs to complete some incomplete information forms during the current shift.

Subsequent to block 308, at block 310, the electronic computing device causes an indication of the total forms completion accumulation value to be provided to one or both of the officer and a dispatcher associated with the officer. In some embodiments, the indication of the total forms completion accumulation value is provided as a visual or audio output indicating the value of the total forms completion accumulation value. As a first example, a visual representation of the hours and minutes of the total forms completion accumulation value may be displayed to the officer on a mobile computing device associated with the officer (e.g., the portable radio 104, the RSM video capture device 106, or the laptop 114 illustrated in FIG. 1). As a second example, a visual representation of the hours and minutes of the total forms completion accumulation value may be displayed to a dispatcher associated with officer (e.g., the dispatch console 158 illustrated in FIG. 1).

Alternatively or in addition, the indication of the total forms completion accumulation value is provided by updating the officer's calendar to include one or more time blocks designated for completing information forms. As a first example, the officer's calendar is updated to include a single continuous time block whose duration is substantially equal to the total forms completion accumulation value. As a second example, the officer's calendar is updated to include two or more separate time blocks whose collective duration is substantially equal to the total forms completion accumulation value. In some embodiments, the officer's calendar is updated via a calendar application or an electronic scheduling database at a mobile computing device associated with the officer. In alternate embodiments, the officer's calendar is updated via a calendar application or an electronic scheduling database at a different computing device (e.g., the infrastructure controller 156, the dispatch console 158, or the database(s) 164 illustrated in FIG. 1).

In some embodiments, the electronic computing device identifies available time periods for the officer to complete information forms based on the officer's expected availability. The officer's expected availability may be determined by identifying intervening appointment blocks in the officer's schedule between the current time and the officer's end-of-shift time. Appointment blocks may include, for example, personal appointment blocks associated with the officer (e.g., scheduled and non-scheduled events for the officer), agency appointment blocks of an agency that the officer belongs to (e.g., non-scheduled events for the officer's department or precinct), or both. A few non-limiting examples of scheduled events for the officer include an end-of-shift time for the officer (e.g., how long the officer has left on their current shift) and court dates. A few non-limiting examples of non-scheduled events for the officer include the officer's preference to actively patrol around a school after it lets out, the officer's preference to take an ad-hoc forty-five minute lunch break, and the drive time back to the station at the end of the officer's shift. A non-limiting example of a non-scheduled event for the officer's agency is that crime usually upticks after school lets out, which adds an average of one hour of form completion time before the officer's scheduled end-of-shift.

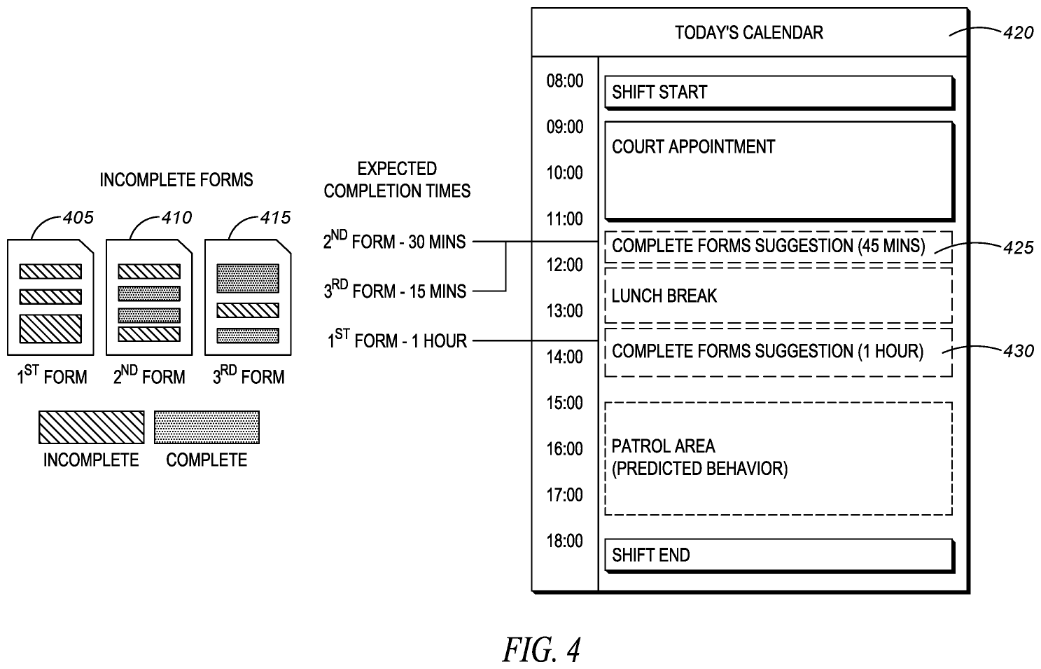

In some embodiments, each time block that is designated for completing information forms specifies one or more suggested information forms for the officer to complete during the time block. In some embodiments, the electronic computing device assigns suggested information forms to specific time blocks based on the expected completion times for the information forms and the durations of available time blocks. For example, FIG. 4 illustrates three information forms with incomplete form sections. A first form 405 illustrated in FIG. 4 includes three incomplete form sections. The expected completion time for the first form 405 is one hour. A second form 410 illustrated in FIG. 4 includes two incomplete form sections. The expected completion time for the second form 410 is thirty minutes. A third form 415 illustrated in FIG. 4 includes one incomplete form section. The expected completion time for the third form 415 is 15 minutes. FIG. 4 also includes an example of a calendar 420 for the officer. The calendar 420 includes, among other things, a first time block 425 and a second time block 430 for completing information forms. The first time block 425 for completing information forms has a duration of forty-five minutes and is included between a scheduled court appearance and the officer's expected lunch break. The second time block 430 for completing information forms has a duration of one hour and is included after the officer's expected lunch break. Given that the first time block 425 is too short for completing the first form 405, the first time block 425 may indicate a suggestion that the officer complete the second form 410 and the third form 415. Following this example, the second time block 430 may thus indicate a suggestion that the officer complete the first form 405.

In some embodiments, the electronic computing device assigns suggested information forms to specific time blocks based on task switching times between information forms and incidents. For example, the officer may be faster at filling out multiple information forms for the same incident than the same amount of work across multiple incidents because of memory recall switching, and may be less for separate related incidents than for separate unrelated incidents. Thus, multiple information forms for a single incident may be suggested for a single time block instead of information forms from separate incidents.

In some embodiments, the electronic computing device assigns suggested information forms to time blocks by prioritizing the information forms required for completion by the officer. In some embodiments, the electronic computing device prioritizes the information forms based on the re-use potential of information entered into form fields in one information form with overlapping form fields required to be completed in other information forms. For example, an information form with multiple form fields that are re-used in other information forms may be prioritized higher than another information form that does not include any form fields that are re-used in other information forms. By prioritizing information forms with higher re-use potential to be completed before other information forms, the overall amount of time needed for the officer to complete all the information forms is reduced. Alternatively or in addition, the electronic computing device prioritizes the information forms based on agency interconnected workflows between roles. For example, the electronic computing device prioritizes the information forms based on an identify of roles of other users that need particular information forms to be complete in order to complete their own particular information forms (an example of “second particular information forms”). The identity of roles of the other users may include, for example, a supervisor, a direct report, an equivalent level role, or a combination thereof. For example, a particular information form may have a high priority because that particular information form needs to enter their supervisor's approval workflow. Alternatively or in addition, the electronic computing device prioritizes the information forms based on set timeframes governed by laws, department rules, and department regulations. For example, laws may require that a specific information form needs to be submitted within seventy-two hours of a suspect being taken into custody. Alternatively or in addition, the electronic computing device prioritizes the information forms based on the estimate completion time for each information forms. For example, information forms with lower estimated completion times are prioritized higher than information forms with higher estimated completion times.

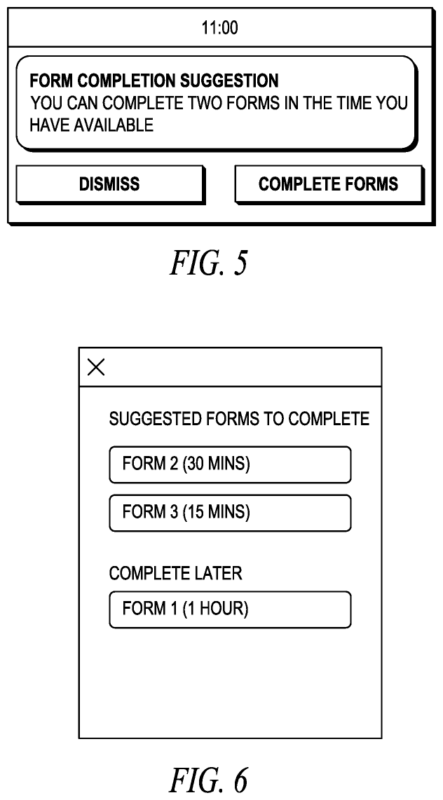

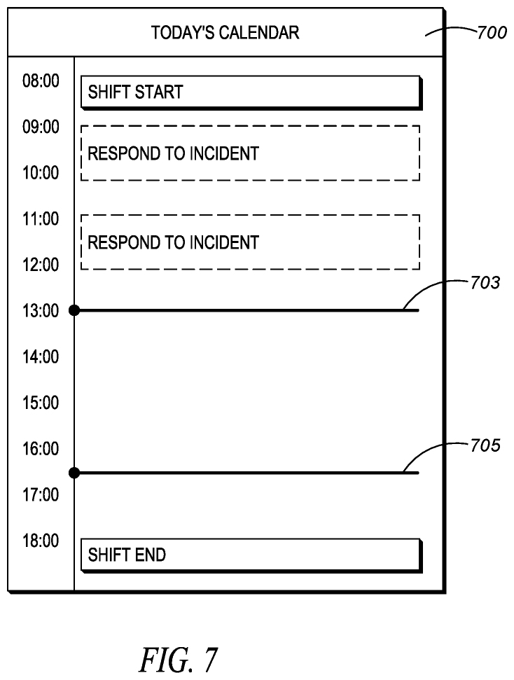

In some embodiments, the calendar application displays a notification when the suggested time (or time block) for form completion is reached. Continuing with the example illustrated in FIG. 4 and previously described herein, FIGS. 5 and 6 are an example of a two-layer calendar notification for the first time block 425. The notification illustrated in FIG. 5 may be displayed on a screen of an electronic device associated with the officer (for example, screen 205 of the communication device 200 previously described herein) when the current time reaches the first time block 425 or when the current time is with predetermined period prior to the first time block 425 (for example, 10 minutes before the first time block 425). As illustrated in FIG. 5, the notification indicates that the officer currently has time available to complete two forms, and the officer may either dismiss the notification by selecting the dismiss virtual button or proceed with completing forms by selecting the complete forms virtual button. Upon selection of the complete forms virtual button, the screen may display suggestions of one or more information forms for the officer to complete during the current time block. For example, with reference to FIG. 6, the second form 410 and the third form 415 are suggested for completion during the first time block 425. In some embodiments, the screen may further display suggestions of one or more information forms to complete at a later time. For example, with reference again to FIG. 6, the first form 405 is suggested for later completion.

In some embodiments, the electronic computing device detects a new (or subsequent) context status change (an example of a “second context status change”) associated with the officer changing status from the second particular status (previously described herein) to an available or idle status (an example of a “third particular status”). Responsive to detecting this new (or subsequent) context status change, the electronic computing device may access an electronic scheduling database associated with the officer and identify, via the scheduling database, an available time for the officer to complete information forms. In some embodiments, the electronic computing device determines an intervening available time between the current time and a next intervening appointment block in the officer's schedule. Alternatively or in addition, the electronic computing device determines an intervening available time between the current time and the officer's end-of-shift time. Upon identifying an available time for the officer to complete information forms, the electronic computing device identifies which particular information forms can be completed by the officer in the intervening available time. The electronic computing device may perform this identification by prioritizing the information forms using any one or more of the prioritization methods previously described herein. The electronic computing device then causes a notification to be provided to the officer to complete the identified information forms that can be completed by the officer in the intervening available time. For example, the electronic computing device may cause a screen of an electronic device associated with the officer (for example, screen 205 of the communication device 200 previously described herein) to display a notification similar to the one illustrated in 5.

In general, an officer wants to complete every required information form prior to the end of their current shift. In some embodiments, the electronic computing device identifies the officer's end-of-shift time by accessing an electronic scheduling database associated with the officer. In some embodiments, the electronic computing device compares the total forms completion accumulation value with a remaining time from the current time to the end of the officer's shift, and causes a notification to be provided to the officer when the total forms completion accumulation value approaches within a predetermined time period (e.g., one to sixty minutes) of the remaining time. Alternatively or in addition, the electronic computing device causes a notification to be provided to the officer when the total forms completion accumulation value is less than or equal to the remaining time. In some embodiments, the electronic computing device determines the remaining time as the total time between the current time and the end of the officer's shift (i.e., not accounting for intervening appointment blocks in the officer's schedule between the current time and the officer's end-of-shift time). In alternate embodiments, the electronic computing device accounts for intervening appointment blocks of scheduled events in the officer's schedule between the current time and the officer's end-of-shift time. For example, when the current time is 1:00 PM, the officer's end-of-shift time is 6:00 PM, and the officer has a court appointment between 3:00 PM and 4:00 PM, the electronic computing device determines a remaining time of four hours. Alternatively or in addition, the electronic computing device accounts for intervening appointment blocks of scheduled and non-scheduled events in the officer's schedule between the current time and the officer's end-of-shift time. For example, when the current time is 1:00 PM, the officer's end-of-shift time is 6:00 PM, and the electronic computing device determines (based on stored historical event data for the officer) that the officer is expected to patrol around a school between 3:00 PM and 5:00 PM, the electronic computing device determines a remaining time of three hours. In some embodiments, the electronic computing device causes different notifications to be provided to the officer to separately indicate the remaining time for form completion including intervening appointment blocks for only scheduled events and the remaining time for form completion including intervening appointment blocks for both scheduled and non-scheduled events.

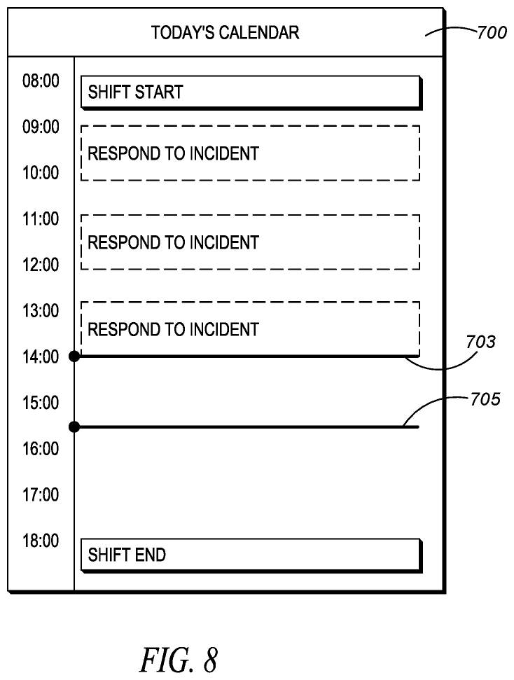

In some embodiments, the electronic computing device causes a calendar application at a mobile computing device associated with the officer to display a moving indicator line indicating an earliest predicted time at which the officer will be able to complete pending information forms taking into consideration the total forms completion accumulation value and remaining appointments associated with the officer appearing in the calendar application (for example, scheduled and non-scheduled events). FIGS. 7 and 8 illustrate an example of an officer's calendar 700 at different times during a day. The officer's calendar 700 including a form indicator line 705 (an example of a “moving indicator line”) indicative of an earliest predicted time at which the officer will be able to complete information forms. In FIG. 7, the current time is 1:00 PM as indicated by current time indicator line 703, and as indicated in FIG. 7, the officer responded to two incidents in the morning. The total forms completion accumulation value for the two incidents is one hour and thirty minutes. Thus, the form indicator line 705 in FIG. 7 is placed at 4:30 PM (i.e., one hour and thirty minutes prior to the end of the shift at 6:00 PM). In FIG. 8, the current time is now 2:00 PM as indicated by the current time indicator line 803, and as indicated in FIG. 8, the officer responded to a third incident between 1:00 PM and 2:00 PM. Assuming that the officer did not complete any information forms while responding to the third incident, the total forms completion accumulation value increases to two hours and thirty minutes as a result of now including the forms required for completion as a result of the officer responding to the third incident. Thus, the form indicator line 705 in FIG. 8 is placed at 3:30 PM (i.e., two hour and thirty minutes prior to the end of the shift at 6:00 PM). In some embodiments, when the moving indicator line approaches within one to sixty minutes of the officer's end-of-shift time or equals the officer's end-of-shift time, the electronic computing device causes a notification to be provided to the officer indicating that the earliest predicted time at which the officer will be able to complete the information forms is approaching or equaling the officer's end-of-shift time.

In some embodiments, the electronic computing device causes the calendar application to display two separate moving indicators lines. The first moving indicator line may indicate the earliest predicted time at which the officer will be able to complete information forms taking into consideration the total forms completion accumulation value and the officer's remaining appointments for scheduled events only. The second moving indicator line may indicate the earliest predicted time at which the officer will be able to complete information forms taking into consideration the total forms completion accumulation value and the officer's remaining appointments for both scheduled and non-scheduled events. For example, when the officer's schedule includes one remaining appointment for a scheduled event and one remaining appointment for a non-scheduled event, the second moving indicator line is placed at an earlier time than the first moving indicator line.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together). The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for electronically monitoring officer context change and accumulating corresponding form completion times and providing an indication thereof, the method comprising:
receiving, at an electronic processor of a computing device, a first context status change associated with an officer changing status from a first particular status to a second particular status, wherein the second particular status is associated with one or more particular information forms required for completion by the officer as a result of the officer obtaining the second particular status;
identifying, by the electronic processor via access to an electronically stored status to form mapping, the one or more particular information forms;
determining, by the electronic processor via access to an electronically stored time completion indication associated with each of the one or more particular information forms, a particular time required by the officer to complete the one or more particular information forms;
adding, by the electronic processor, the particular time to a total forms completion accumulation value particularly associated with the officer; and
subsequently causing, by the electronic processor, an indication of the total form completion accumulation value particularly associated with the officer to be provided to one or both of the officer and a dispatcher associated with the officer.

2. The method of claim 1, further comprising:
accessing, by the electronic processor, an electronic scheduling database associated with the officer and identifying, via the electronic scheduling database, an end-of-shift time associated with the officer;
comparing, by the electronic processor, the total forms completion accumulation value with a remaining time from a current time to the end-of-shift time associated with the officer; and
when the total forms completion accumulation value approaches within one to sixty minutes of or is less than the remaining time, causing a notification to be provided to the officer indicative of the total forms completion accumulation value approaching within one to sixty minutes of or being less than the remaining time.

3. The method of claim 1, further comprising:
accessing, by the electronic processor, an electronic scheduling database associated with the officer;
identifying, via the electronic scheduling database, an end-of-shift time associated with the officer and one or more intervening appointment blocks between a current time and the end-of-shift time;
subtracting the one or more intervening appointment blocks from a difference between the current time and the end-of-shift time associated with officer to determine a remaining time;
comparing, by the electronic processor, the total forms completion accumulation value with the remaining time; and
when the total forms completion accumulation value approaches within one to sixty minutes of or equals the remaining time, causing a notification to be provided to the officer indicative of the total forms completion accumulation value approaching within one to sixty minutes if or equaling the remaining time.

4. The method of claim 3, wherein identifying, via the electronic scheduling database, the one or more intervening appointment blocks between the current time and the end-of-shift time comprises accessing personal appointment blocks associated with the officer and agency appointment blocks of an agency that the officer belongs to.

5. The method of claim 1, further comprising prioritizing the one or more particular information forms for completion by the officer based on a re-use potential of information entered into form fields in one form with overlapping form fields required to be completed in other forms.

6. The method of claim 1, further comprising prioritizing the one or more particular information forms for completion by the officer based on an identity of roles of other users that need the one or more particular information forms to be completed in order to complete their own second particular information forms.

7. The method of claim 6, wherein the identity of roles of other users includes at least one selected from a group consisting of a supervisor, a direct report, and an equivalent level role.

8. The method of claim 1, further comprising prioritizing the one or more particular information forms for completion by the officer based on an estimate completion time for each of the one or more particular information forms, the one or more particular information forms having lower estimated completion times being higher prioritized than the one or more particular information forms having higher estimated completion times.

9. The method of claim 1, further comprising detecting, by the electronic processor, a second context status change associated with the officer changing status from the second particular status to a third particular status that indicates that the officer is available or idle, and responsively:
accessing, by the electronic processor, an electronic scheduling database associated with the officer;
identifying, via the scheduling database, an intervening available time between a current time and a next intervening appointment block or between the current time and an end-of-shift time associated with the officer;
identifying, by the electronic processor, which of the one or more particular information forms can be completed by the officer in the intervening available time; and
causing, by the electronic processor, a notification to be provided to the officer to complete the identified one or more particular information forms that can be completed by the officer in the intervening available time.

10. The method of claim 1, wherein the first particular status is an idle or available state, and wherein the second particular status is assigned to a particular incident of a particular incident type.

11. The method of claim 10, wherein the step of identifying, via access to the electronically stored status to form mapping, the one or more particular information forms comprises:
identifying the one or more particular information forms required for an incident having the particular incident type.

12. The method of claim 11, wherein the step of determining, via access to the electronically stored time completion indication associated with each of the one or more particular information forms, the particular time required by the officer to complete the one or more particular information forms comprises at least one selected from a group consisting of (i) extracting the particular time from metadata embedded within retrieved copies of the one or more particular information forms, (ii) retrieving the particular time from the electronically stored status to form mapping, and (iii) retrieving the particular time from a form completion database separate from the electronically stored status to form mapping.

13. The method of claim 1, wherein the particular time is determined based on a stored calculated historical average for a plurality of other officers to complete the one or more particular information forms.

14. The method of claim 1, wherein the particular time is determined based on a stored configured time to complete the one or more particular information forms.

15. The method of claim 1, wherein the particular time is determined by eliminating overlapping form fields of the one or more particular information forms and any other forms for any other secondary context status changes detected associated with the officer and subsequently auto-populating the overlapping form fields when a first one of the overlapping form fields is populated.

16. The method of claim 1, wherein subsequently causing the indication of the total form completion accumulation value particularly associated with the officer to be provided to the officer comprises causing a visual or audio output to be provided at a mobile computing device associated with the officer setting forth a value of the total forms completion accumulation value.

17. The method of claim 1, wherein subsequently causing the indication of the total form completion accumulation value particularly associated with the officer to be provided to the officer comprises causing a calendar application at a mobile computing device associated with the officer to be updated to indicate one or more time blocks indicative of the total forms completion accumulation value.

18. The method of claim 1, wherein subsequently causing the indication of the total form completion accumulation value particularly associated with the officer to be provided to the officer comprises causing a calendar application at a mobile computing device associated with the officer to display a moving indicator line indicative of an earliest predicted time at which the officer will be able to complete the one or more particular information forms taking into consideration the total forms completion accumulation value and remaining appointments associated with the officer appearing in the calendar application; and
when the moving indicator line approaches within one to sixty minutes or equals an indicated end-of-shift time in the calendar application, causing a notification to be provided to the officer indicative of the earliest predicted time at which the officer will be able to complete the one or more particular information forms approaching or equaling the indicated end-of-shift time.

19. A computing device for electronically monitoring officer context change and accumulating corresponding form completion times and providing an indication thereof, the computing device comprising:
a memory;
a transceiver;
an output interface; and
an electronic processor configured to:
receive a context status change associated with an officer changing status from a first particular status to a second particular status, wherein the second particular status is associated with one or more particular information forms required for completion by the officer as a result of the officer obtaining the second particular status,
identify, via access to an electronically stored status to form mapping, the one or more particular information forms,
determine, via access to an electronically stored time completion indication associated with each of the one or more particular information forms, a particular time required by the officer to complete the one or more particular information forms,
add the particular time required to a total forms completion accumulate value particularly associated with the officer, and
subsequently cause an indication of the total form completion accumulation value particularly associated with the officer to be provided to one or both of the officer and a dispatcher associated with the officer.

20. A non-transient computer readable medium containing program instructions for causing a computer to perform a set of functions comprising:
receive a context status change associated with an officer changing status from a first particular status to a second particular status, wherein the second particular status is associated with one or more particular information forms required for completion by the officer as a result of the officer obtained the second particular status;
identify, via access to an electronically stored status to form mapping, the one or more particular information forms;
determine, via access to an electronically stored time completion indication associated with each of the one or more particular information forms, a particular time required by the officer to complete the one or more particular information forms;
add the particular time required to a total forms completion accumulate value particularly associated with the officer; and
subsequently cause an indication of the total form completion accumulation value particularly associated with the officer to be provided to one or both of the officer and a dispatcher associated with the officer.
